(19) United States
(12) Patent Application Publication
(10) Pub. No.: US 2016/0137507 A1
(43) Pub. Date: May 19, 2016

(54) LARGE-AREA GRAPHENE TRANSFER METHOD

(71) Applicants: INSTITUTE FOR BASIC SCIENCE, Daejeon (KR); UNIST ACADEMY-INDUSTRY RESEARCH CORPORATION, Ulsan (KR)

(72) Inventors: Xuequi YOU, Ulsan (KR); Da Luo, Ulsan (KR); Rodney S. Ruoff, Ulsan (KR)

(73) Assignees: INSTITUTE FOR BASIC SCIENCE, Daejeon (KR); UNIST ACADEMY-INDUSTRY RESEARCH CORPORATION, Ulsan (KR)

(21) Appl. No.: 14/547,551

(22) Filed: Nov. 19, 2014

(51) Int. Cl. C01B 31/04; B32B 37/00; B32B 9/00

(52) U.S. Cl. CPC C01B 31/0438; B32B 9/007; B32B 37/025; B32B 2457/00; B32B 2309/02

(57) ABSTRACT

A graphene transfer method using water vapor-assisted determination of CVD-grown graphene film on the Cu foil. By using the polymer film as a supporting layer, we found that graphene can be directly detached from the Cu foil as a consequence of water intercalated at the graphene-Cu interface(s), by a ‘dry transfer’ method. The delaminated graphene films are continuous over large area. This nondestructive method also worked for the transfer of graphene grown on a Cu single crystal without sacrificing the expensive crystal, thus affording the possibility of producing high-quality graphene and reusing the substrate. The Cu foil and single crystal can both be repeatedly used for many times, which may reduce the cost of graphene synthesis and is environmentally more benign. Our method affords the advantages of high efficiency, likely industrial scalability, minimal use of chemicals, and the reusability of the Cu foil in multiple growth and delamination cycles.

### FIELD OF THE INVENTION

The present invention relates generally to a method for transferring large-area graphene. More specifically, the present invention is a water vapor-assisted delamination method for transferring large-area CVD-grown graphene onto arbitrary substrates.

### BACKGROUND OF THE INVENTION

Graphene, a two-dimensional monolayer of sp²-bonded carbon atoms, has been the focus of much research since its isolation because of the unique transport properties. Because of graphene's high optical transmittance and conductivity it is also being considered as a transparent conductive electrode. In comparison to traditional transparent conductive electrodes, graphene films have high mechanical strength, flexibility and chemical stability. Production of large-area and high-quality graphene film is necessary for electronic products such as touch screen displays, e-paper (electronic paper) and organic light-emitting diodes (OLEDs).

Many studies for transferring large-area graphene films to target substrate are carried out in recent years. Among those studies, Xuesong Li et al. produced single-layered graphene films on copper foils and suggested two wet-transfer methods to transfer graphene from copper foil. However, their transfer methods need a wet-etching process to etch the copper foils (Xuesong Li et al., Large-arm synthesis of high-quality and uniform graphene films on copper foils, Science 324, 1312-1314(2009), the entire contents are incorporated herein by reference), which may be shortcoming in overall graphene transfer process. And also, they reported on an improved transfer process of large-area graphene grown on copper foils by chemical vapor deposition (CVD). The transferred graphene films had high electrical conductivity and high optical transmittance that make them suitable for transparent conductive electrode applications. In spite of their improved performances, copper foil was still etched away by an aqueous solution of iron nitrate over a period of ˜12 hr (Xuesong Li et al., Transfer of large-area graphene films for high-performance transparent conductive electrodes, Nano letters 9(12), 4359-4363(2009), the entire contents are incorporated herein by reference), which may be also demerit in respect of scalable process cost for large-area production.

In addition to documents mentioned above, some other papers or patents are known to electronic devices production industry pursuing higher quality large-area graphene films. In most of papers or patents, however, wet-etching process using chemical etchants to etch the substrate such as copper foil may be reason of undesirable doping and surface contamination, which results In lower quality large-area graphene films (Keun Soo KIM et al., Large scale-pattern growth of graphene films for stretchable transparent electrodes, Nature letters 457, 706-710 (2009); Yung-chang Lin et al., Cleaner transfer of graphene for isolation and suspension, ACS Nano 5(3); 2382-2388(2011); KIM et al., Graphene transfer method, WO 2013/048083 A1; Richard S. Ploss, J R., Material trivial transfer graphene, US 2013/0248087 A1, the entire contents are incorporated herein by reference).

Therefore, one of objectives of the present invention is to provide cleaner CVD graphene films minimizing undesirable doping and surface contamination by the lack of chemical etchants, which results in higher quality large-area graphene. The other objective of the present invention is to provide process allowing the reuse of substrates and enabling the use of oriented substrates for growth of higher quality large-area graphene. According to the present invention, inherently inexpensive graphene can be produced by lowering the graphene production cost in the scalable process for large-area production.

### BRIEF SUMMARY OF THE INVENTION

The aforementioned problems are overcome in the present invention which provides a graphene transfer method using water vapor-assisted determination of CVD-grown graphene film on copper (Cu) foil. By using the polymer film as a supporting layer, we found that graphene can be directly detached from the Cu foil as a consequence of water intercalated at the graphene-Cu interfaces), by a ‘dry transfer’ method. The delaminated graphene films are continuous over large area. This nondestructive method also worked for the transfer of graphene grown on a Cu single crystal without sacrificing the expensive crystal, thus affording the possibility of producing high-quality graphene and reusing the substrate. The Cu foil and single crystal can both be repeatedly used for many times, which may reduce the cost of graphene synthesis and is environmentally more benign. Our method affords the advantages of high efficiency, likely industrial scalability, minimal use of chemicals, and the reusability of the Cu foil (and in general, the growth substrate) in multiple growth and delamination cycles.

### BRIEF DESCRIPTION OF THE DRAWINGS

FIG. 1 shows a schematic description of the novel graphene transfer method suggested in the present invention.

(a) Graphene grown on Cu foil by CVD method

(b) Graphene/Cu is placed in a high humidity chamber for wafer vapor treatment

(c) Water intercalated at the interface of graphene-Cu after water vapor treatment

(d) Spin coat polycarbonate (PC) onto graphene, physical pressure, high temperature are applied across the sample

(e) After applying pressure and high temperature, the graphene/PC is physically exfoliated from the Cu foil

(f) Graphene/PC can be transferred onto any target substrate, such as SiO₂ substrate. High temperature is applied in order to improve the adhesion between graphene and the target substrate

(g) Remove the PC by dissolving it in chloroform

(h) Demonstration of graphene transferred on SiO₂ substrate

FIG. 2 shows a schematic diagram of the setup for the high humidity exposure experiment.

FIG. 3 shows surface morphology of graphene on Cu foil

FIG. 4 shows (a) AFM image of graphene transferred on to SiO₂ substrate, (b) optical image of graphene transferred on to SiO₂ substrate, (c) AFM profiles of graphene transferred on to SiO₂ substrate and (d) Raman spectra of graphene on PC and graphene transferred on SiO₂ substrate.

FIG. 5 shows large-area graphene film transferred from single crystal (top) and polycrystalline Cu foil (bottom) to the target substrate (SiO2 substrate) according to the present invention.

### DETAILED DESCRIPTION OF THE INVENTION

The present invention is directed towards a method for transferring large-area graphene. One of the most important technical features of the present invention is water vapor-assisted delamination method for being able to transfer large-area CVP-grown graphene onto any substrates. The other one is dry-transfer process, where the graphene can be directly peeled off from the growth substrates without etching the growth substrates.

The present invention provides a graphene transfer method comprising the steps of; i) incubating graphene/growth substrate with water vapor treatment; ii) coating vapor treated graphene/growth substrate using polymer; iii) enhancing polymer adhesion to graphene; iv) separating the graphene/polymer from the growth substrate; v) transferring the graphene/polymer to the target substrate; and vi) removing the polymer from graphene/polymer on the target substrate.

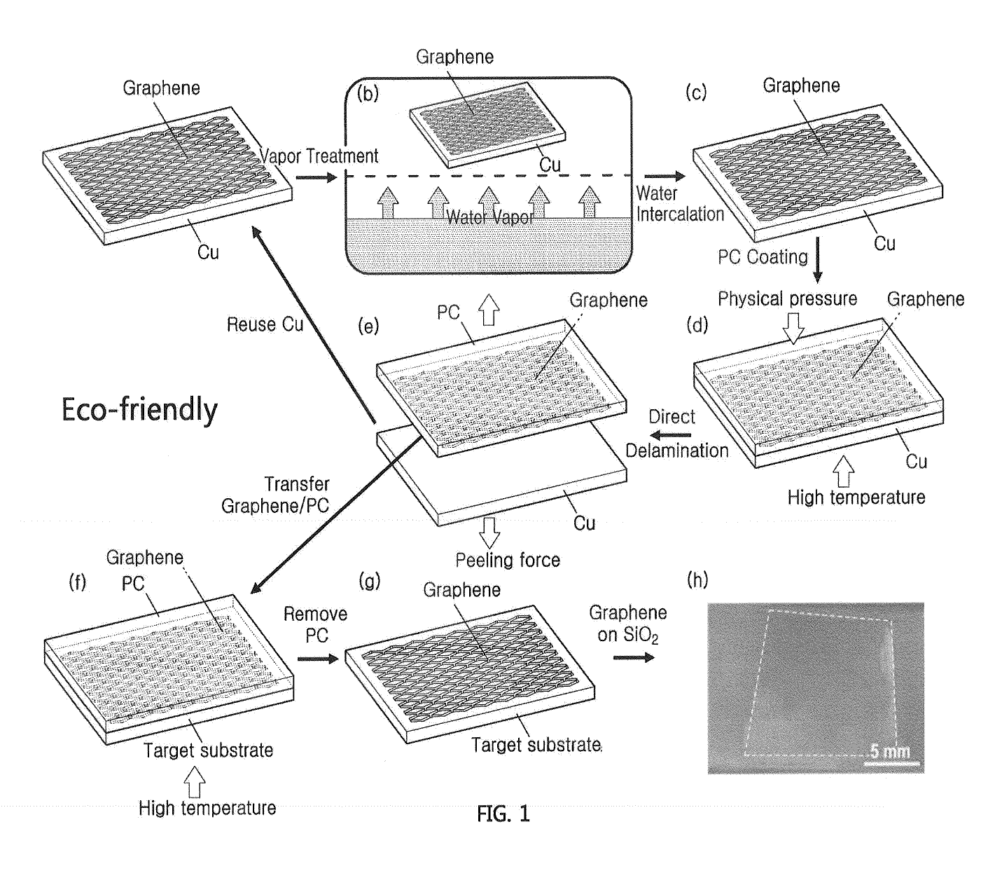

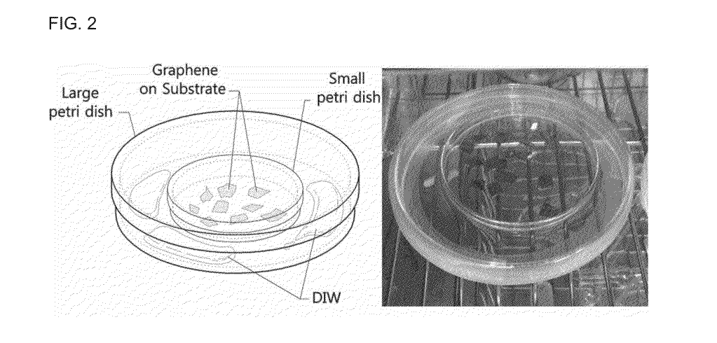

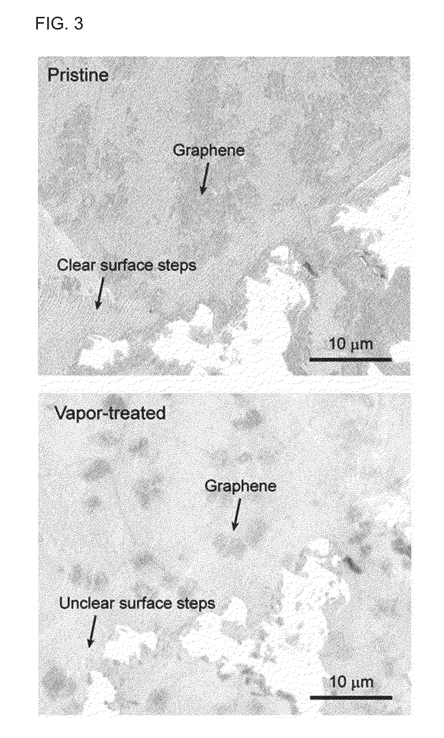

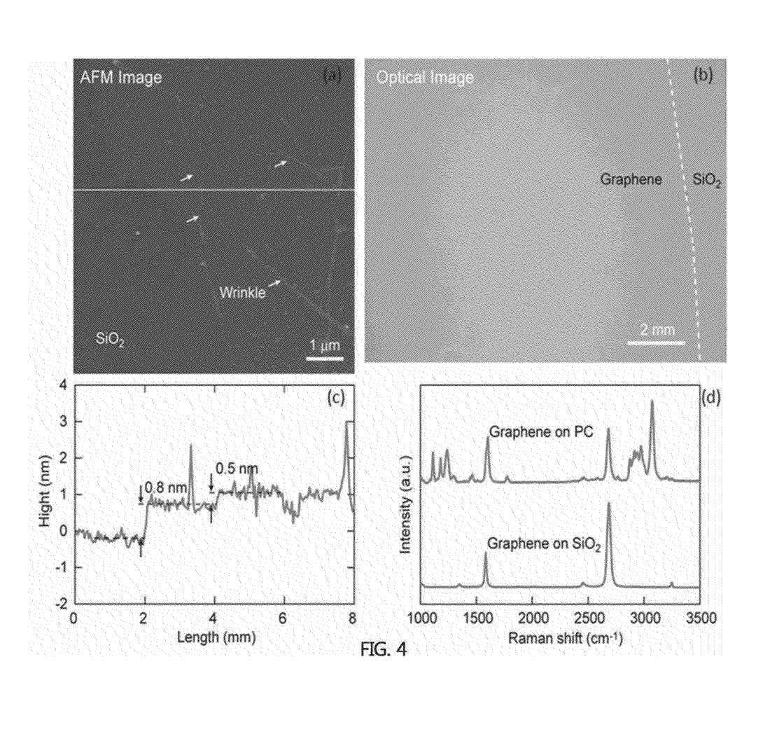

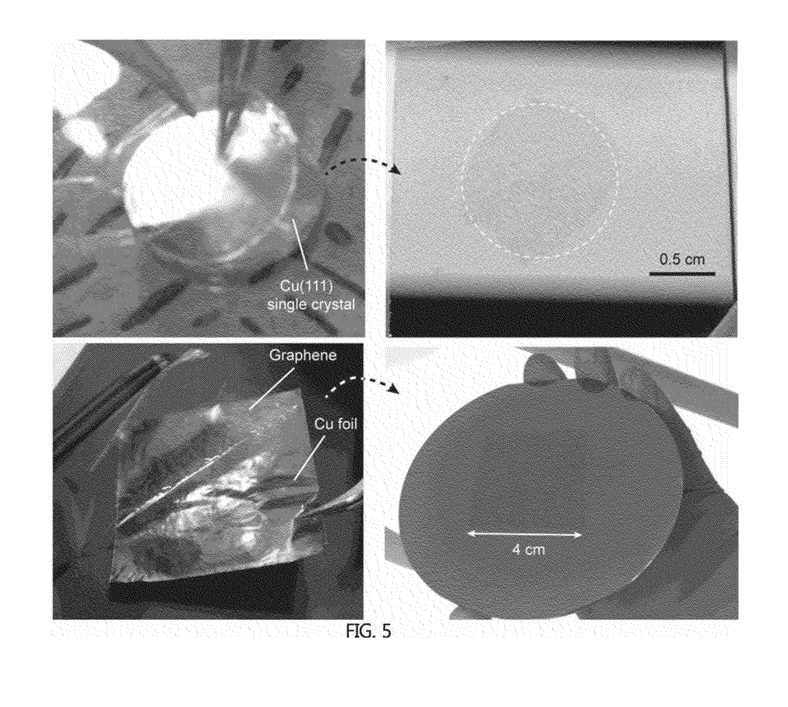

FIG. 1 shows a schematic description of the novel graphene transfer method comprising the steps said above, which is only suggested as a specific example of the present invention and does not limit the scope of the present invention. Each step is described in detail in the following sections.

Step i): incubating graphene/growth substrate with water vapor treatment

First of all, graphene sheets were grown by atmospheric pressure CVD of methane (99.99%) on growth substrate. In the present invention, the growth substrate includes copper foil, silicon carbide (SiC), silicon oxide (SiO₂), aluminum oxide (Al₂O₃), boron nitride (BN), or gallium nitride (GaN). In a preferred embodiment, the growth substrate is copper foil. Prior to growth, the Cu foils were cleaned by acetic acid to remove surface oxides. Then, the Cu foils were mounted in the CVD chamber with a steady 10 sccm flow of hydrogen. The furnace was ramped up to 1000° C. over 40 min. In the CVD process, methane (20 sccm) mixed with argon (230 sccm) and hydrogen (10 sccm) was fed into the reaction chamber for 10 min during which graphene growth occurs. The Cu foils were then cooled down rapidly. Then, in order to perform high humidity exposure experiments, graphene on CM foil was placed in a Petri dish (55 mm diameter and 12 mm height), which was placed in another larger dish (90 mm diameter and 15 mm height). A small amount of deionized water (DIW, 15 ml) was then injected into the larger dish, which was covered and seated such that the system was isolated from the relatively dry environment (with a temperature and relative humidity of 20-50° C. and <90%, respectively). An illustration of our setup for reaching high humidity conditions is shown in FIG. 2. Two Petri dishes were used in order to prohibit DIW from directly making contact with the graphene sample. Water intercalated at the interface of graphene/Cu after water vapor treatment for 1˜12 hr, FIG. 3 shows surface morphology of graphene on Cu foil. Cu surface steps disappeared after water vapor treatment and graphene image contrast became brighter due to water intercalation, which could be an evidence for water intercalation into the interface of graphene on Cu foil. This method uses only water vapor, hence contamination due to ionic species can be significantly reduced ensuring that the electrical properties are not degraded as typically seen for graphene transferred via processes using chemical etchants to remove the Cu substrate.

Step ii): coating vapor treated graphene/growth substrate using polymer

Water vapor treated graphene/growth substrate was coated with polymer. The polymer for coating graphene/growth substrate can be polycarbonate (PC), poly(hexahydrotriazine)s (PHTs), polyethylene glycol) (PEG), polymethylmethacrylate (PMMA), polyethylene terephthalate (PET), poly(etherimide) (PEI), poly(dimethylsiloxane) (PDMS), poly(oxymethylene) (POM), liquid crystal polymer (LCP), poly(phenylenether) (PPE), polyethylene (PE), polysulfone (PSF), cycloolefin copolymer (COC), poly(butylene terephthalate) (PBT), polyamide (PA), polypropylene (PP), poly(etheretherketone) (PEEK), polystyrene (PS), or polylactide (PLA). In a preferred embodiment, PC was used as the polymer for coating graphene/growth substrate.

PC (bisphenol A type) was dissolved in chloroform (solid content; less than 15 wt %). The PC/chloroform solution was spin-coated onto the Graphene/Cu/SiO₂/Si substrate with 3000 rpm for 1 min. The coating was homogeneous with thickness less than 50 μm.

Step iii): enhancing polymer adhesion to graphene

In order to enhance polymer adhesion to graphene, pressure and heat were employed to graphene/polymer/growth substrate, 0.1˜1.0 Kgf/cm² of pressure and 150˜200° C. of heat can be applied to the graphene/polymer/growth substrate for 5˜30 mins. In a preferred embodiment, mechanical pressing (0.15 Kgf/cm²) over the contacting area and heat (on a 180° C. plate) are applied to the graphene/PC/Cu foil simultaneously for 15 mins.

Step iv): separating the graphene/polymer from the graphene/polymer/growth substrate

We could be able to separate the graphene/polymer from the graphene/polymer/growth substrate by a simple physical means. After having maintained step i) for several tens of minutes, we took out the integrated sample (the polymer (preferably, PC) film with adhered graphene on Cu foil) from the apparatus when the temperature decreased till 90° C. Immediately after having taken out the sample, we then carefully pulled the edge of Cu foil using tweezers by hand.

Step v): transferring the graphene/polymer to the target substrate

Graphene/polymer can be transferred onto any target substrate, such as SiO₂ substrate. High temperature (150˜200° C.) is applied in order to improve the adhesion between graphene and the target substrate for 3˜10 mins. In the present invention, the target substrate includes silicon carbide (SiC), silicon oxide (SiO₂), aluminum oxide (Al₂O₃), boron nitride (BN), or gallium nitride (GaN). In a preferred embodiment graphene/PC was attached on SiO₂ substrate as a target substrate by heating oh a 180° C. plate for 5 mins.

Step vi): removing the polymer from graphene/polymer on the target substrate

Finally, high-quality graphene on target substrate is obtained by removing the polymer from graphene/polymer on the target substrate. In a preferred embodiment, we were simply able to prepare high-quality graphene transferred on SiO₂ substrate by dissolving PC in a solvent, preferably chloroform.

FIG. 4 shows (a) AFM image of graphene transferred on to SiO₂ substrate and (b) optical Image of graphene transferred on to SiO₂ substrate, indicating that graphene is continuous over the surface. In addition, we can see that the monolayer graphene thickness is less than 0.8 nm and the double layer graphene thickness is less than 1.3 nm, respectively, from the AFM profiles of graphene transferred on to SiO₂ substrate (FIG. 4 (c)). And also, we can observe distinct peaks of G and 2D peaks from original PC peaks from the Raman spectra of graphene on PC and graphene transferred on SiO₂ substrate shown in FIG. 4(d).

In the present invention, accordingly, large-area graphene film was successfully transferred from single crystal (top) and polycrystalllne Cu foil (bottom) to the target substrate (SiO₂ substrate) as shown in FIG. 5.

According to graphene transfer method of the present invention, we can provide cleaner CVD graphene films minimizing undesirable doping and surface contamination by the lack of chemical etchants, which results in higher quality large-area graphene. Moreover, our method suggests the process allowing the reuse of substrates and enabling the use of oriented substrates for growth of higher quality large-area graphene. Hence, inherently inexpensive graphene can he produced by lowering the graphene production cost in the scalable process for large-area production. The graphene prepared in the present invention can be specially applied to flexible electronic devices due to outstanding mechanical flexibility and chemical durability as well as electronic products such as touch screen displays, e-paper (electronic paper) and organic light-emitting diodes (OLEDs).

While the present invention has been described with respect to the specific embodiments, it will be apparent to those skilled in the art that various changes and modifications may be made without departing from the spirit and scope of the invention as defined in the following claims.

What is claimed is:

1. A graphene transfer method comprising the steps of:
i) incubating graphene/growth substrate with water vapor treatment;
ii) coating vapor treated graphene/growth substrate using polymer;
iii) enhancing polymer adhesion to graphene;
iv) separating the graphene/polymer from the graphene/polymer/growth substrate;
v) transferring the graphene/polymer to the target substrate; and
vi) removing the polymer from graphene/polymer on the target substrate.

2. The graphene transfer method according to claim 1, wherein said growth substrate is any one selected from the group consisting of copper foil, silicon carbide (SiC), silicon oxide (SiO₂), aluminum oxide (Al₂O₂), boron nitride (BN), and gallium nitride (GaN).

3. The graphene transfer method according to claim 1, wherein said water vapor treatment is carried out for 1 to 12 hours.

4. The graphene transfer method according to claim 1, wherein said polymer is any one selected torn the group consisting of polycarbonate (PC), poly(hexahydrotriazine)s (PHTs), polyethylene glycol) (PEG), polymethylmethacrylate (PMMA), polyethylene terephthalate (PET), poly(etherimide) (PEI), poly(dimethylsiloxane) (PDMS), poly(oxymethylene) (POM), liquid crystal polymer (LCP), poly(phenylenether) (PPE), polyethylene (PE), polysulfone (PSF), cycloolefin copolymer (COC), poly(butylene terephthalate) (PBT), polyamide (PA), polypropylene (PP), poly(etheretherketone) (PEEK), polystyrene (PS), and polylactide (PLA).

5. The graphene transfer method according to claim 4, wherein said polymer is polycarbonate(PC).

6. The graphene transfer method according to claim 1, wherein said coating is carried out by spin coating process.

7. The graphene transfer method according to claim 1, wherein said enhancing polymer adhesion to graphene is carried out by applying pressure and heat to the graphene/polymer/growth substrate for 5 to 30 minutes.

8. The graphene transfer method according to claim 7, wherein said pressure and heat applied to the graphene/polymer/growth substrate ranges from 0.1 to 1.0 Kgf/cm² and from 150 to 200° C., respectively.

9. The graphene transfer method according to claim 1, wherein said separating of the graphene/polymer from the graphene/polymer/growth substrate is carried out by a physical means.

10. The graphene transfer method according to claim 1 wherein said transferring of the graphene/polymer to the target substrate is carried out by applying 180 to 200° C. of temperature for 3 to 10 minutes.

11. The graphene transfer method according to claim 9, wherein said target substrate is any one selected from the group consisting of silicon carbide (SiC), silicon oxide (SiO₂), aluminum oxide (Al₂O₃), boron nitride (BN), and gallium nitride (GaN).

12. The graphene transfer method according to claim 1 wherein said removing of the polymer from graphene/polymer on the target substrate is carried out by dissolving the polymer in a solvent.

13. The large-area graphene transferred on target substrate using a method of claim 1.

14. An electronic device comprising the large-area graphene according to claim 13.

15. The electronic device according to claim 14, wherein said electronic devices are flexible electronic devices.
